(19) United States
(12) Patent Application Publication
(10) Pub. No.: US 2026/0333397 A1
(43) Pub. Date: Oct. 22, 2026

(54) METHOD PERFORMED BY USER EQUIPMENT, AND USER EQUIPMENT

(71) Applicant: Sharp Kabushiki Kaisha, Sakai City, Osaka (JP)

(72) Inventors: Chao LUO, Shanghai (CN); Yinan ZHAO, Shanghai (CN); Renmao LIU, Shanghai (CN)

(21) Appl. No.: 19/166,307

(22) PCT Filed: Mar. 20, 2024
(86) PCT No.: PCT/CN2024/082685

§ 371 Date: Sep. 17, 2025

(30) Foreign Application Priority Data
Mar. 20, 2023 (CN) 202310275099.5

(51) Int. Cl. H04W 72/25; H04B 17/318; H04W 72/0446; H04W 72/0457; H04W 92/18

(52) U.S. Cl. CPC H04W 72/25; H04B 17/318; H04W 72/0446; H04W 72/0457; H04W 92/18

(57) ABSTRACT

Provided in the present invention are a method performed by a user equipment, and a user equipment. The method performed by a user equipment includes: obtaining configuration information related to a sidelink received signal strength indicator (RSSI) measurement, comprising a first starting sidelink symbol in a sidelink bandwidth part which is configured according to a first parameter, and a second starting sidelink symbol which is configured according to a second parameter, wherein the second starting sidelink symbol is later than the first starting sidelink symbol; and performing the sidelink RSSI measurement in a sidelink symbol set in a slot, wherein if a PSFCH is not configured in the slot, the sidelink symbol set consists of symbols in the slot starting from the second starting sidelink symbol and configured for a physical sidelink control channel (PSCCH) and a physical sidelink shared channel (PSSCH).

### TECHNICAL FIELD

The present invention relates to a method performed by a user equipment, and a user equipment.

### BACKGROUND ART

In a wireless communication system, information may be exchanged between different communication nodes. Wireless communication may be performed on a licensed spectrum and/or an unlicensed spectrum. One example of a wireless communication system is a system standardized by the 3rd Generation Partnership Project (3GPP), for example, a 4G system based on Long-Term Evolution (LTE) radio access technology or an evolved system thereof, or a 5G system based on New Radio (NR) radio access technology or an evolved system thereof. In a communication system based on 3GPP specifications, examples of the communication nodes may include a user equipment (UE) and a base station (e.g., an eNB or a gNB). A radio link from a base station to a UE may be referred to as a downlink (DL). A radio link from a UE to a base station may be referred to as an uplink (UL). A radio link between UEs may be referred to as a sidelink (SL). An interface for wireless transmission and/or reception between a base station and a UE may be referred to as a Uu interface (e.g., an NR-Uu interface based on NR, or an LTE-Uu interface based on LTE). An interface for wireless transmission and/or reception between UEs may be referred to as a PC5 interface (e.g., an NR-PC5 interface based on NR, or an LTE-PC5 interface based on LTE).

In order to support communication on a licensed spectrum and/or an unlicensed spectrum, a series of issues need to be addressed, such as channel access mechanisms, physical layer channel and/or signal structures, physical layer control information and/or signaling procedures (e.g., a synchronization procedure and a feedback and/or determination mechanism), control information and/or signaling procedures of a higher layer, resource allocation and/or management, and coexistence among different systems.

### PRIOR ART DOCUMENTS

### Non-Patent Documents

Non-Patent Document 1: RP-170379, Revision of SI: Study on New Radio Access Technology, 3GPP TSG RAN Meeting #75
Non-Patent Document 2: RP-191971, Revised WID: New Radio Access Technology, 3GPP TSG RAN Meeting #85
Non-Patent Document 3: RP-190224, Revised SID: Study on NR V2X, 3GPP TSG RAN Meeting #83
Non-Patent Document 4: RP-200129, Revised WID on 5G V2X with NR sidelink, 3GPP TSG RAN Meeting #87-e
Non-Patent Document 5: RP-202846, Revised WID on NR Sidelink enhancement, 3GPP TSG RAN Meeting #90-e
Non-Patent Document 6: RP-222806, Revised WID: NR sidelink evolution, 3GPP TSG RAN Meeting #98-e

### SUMMARY OF THE INVENTION

To resolve at least some of the foregoing problems, the present invention provides a method performed by a user equipment and a user equipment, to determine a symbol set for a sidelink measurement (e.g., a sidelink RSSI) according to information such as a configuration of a starting sidelink symbol (e.g., the number of starting sidelink symbols) in a slot, thereby preventing to the greatest extent a situation in which actual sidelink transmission exists in only a part of a plurality of measured symbols, and greatly improving accuracy of the sidelink measurement.

According to the present invention, a method performed by a user equipment is provided. The method is characterized by comprising: obtaining configuration information related to a sidelink received signal strength indicator (RSSI) measurement, and performing the sidelink RSSI measurement in a sidelink symbol set in a slot in a resource pool, wherein if the slot comprises one starting sidelink symbol, a first symbol in the sidelink symbol set is determined according to the starting sidelink symbol, and if the slot comprises two starting sidelink symbols, the first symbol in the sidelink symbol set is determined according to a second starting sidelink symbol in the two starting sidelink symbols.

Furthermore, according to the present invention, a user equipment is provided, comprising: a processor; and a memory storing instructions, wherein the instructions, when run by the processor, perform the above method.

Therefore, the present invention provides a method, to determine a symbol set for a sidelink measurement (e.g., a sidelink RSSI) according to information such as a configuration of a starting sidelink symbol (e.g., the number of starting sidelink symbols) in a slot, thereby preventing to the greatest extent a situation in which actual sidelink transmission exists in only a part of a plurality of measured symbols, and greatly improving accuracy of the sidelink measurement.

### BRIEF DESCRIPTION OF THE DRAWINGS

The above and other features of the present invention will be more apparent from the following detailed description in combination with the accompanying drawings, in which:

FIG. 1 shows a flowchart corresponding to a method performed by a user equipment according to Embodiment 1 of the present invention.

FIG. 2 shows a flowchart corresponding to a method performed by a user equipment according to Embodiment 2 of the present invention.

FIG. 3 shows a flowchart corresponding to a method performed by a user equipment according to Embodiment 3 of the present invention.

FIG. 4 shows a block diagram of a user equipment according to the present invention.

### DETAILED DESCRIPTION OF PREFERRED EMBODIMENTS

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to prevent the understanding of the present invention from being obscured.

A plurality of embodiments according to the present invention will be specifically described below using 5G (also referred to as NR or 5G NR) wireless communication system specifications formulated by the 3GPP and subsequent evolved versions thereof (e.g., 5G Advanced) as an exemplary application environment. However, it shall be noted that the present invention is not limited to the following embodiments, but rather is applicable to many other wireless communication systems, such as wireless communication systems later than 5G, or 4G mobile communication systems earlier than 5G, e.g., Long Term Evolution (LTE), LTE-Advanced, LTE-Advanced Pro, etc.

The terms given in the present invention may be named differently in different wireless communication systems, but unified terms are used in the present invention. When applied to a specific system, the terms may be replaced with terms used in the corresponding system.

Unless otherwise specified, in all embodiments and implementations of the present invention:
“Node” and “communication node” may be interchangeable.
The “node” (or “communication node”) may refer to a UE, or a network node (e.g., a base station), or a communication node in another form.
“Base station” may refer to a 4G base station, e.g., an eNB (E-UTRAN Node B, wherein E-UTRAN stands for Evolved Universal Terrestrial Radio Access Network); or a 5G base station, e.g., a gNB (a node that provides NR user plane and control plane protocol terminations to a UE and is connected to a 5G core network via an NG interface), or an ng-eNB (a node that provides E-UTRA user plane and control plane protocol terminations to a UE and is connected to a 5G core network via an NG interface, wherein E-UTRA stands for Evolved Universal Terrestrial Radio Access); or a base station in another form.
“Lower layer(s)” may refer to one or more protocol layers or protocol sub-layers below a reference protocol layer or a reference protocol sub-layer in a specific protocol stack. For example, if the reference protocol layer or the reference protocol sub-layer is an RRC layer, then “lower layer” may refer to a MAC layer, and/or a physical layer; as another example, if the reference protocol layer or the reference protocol sub-layer is a MAC layer, then “lower layer” may refer to a physical layer. Unless otherwise specified, the reference protocol layer or the reference protocol sub-layer is a MAC layer. A “lower layer” may also be referred to as a “low layer” if this causes no ambiguity.
“Higher layer(s)” or “upper layer(s)” may refer to, in a particular protocol stack (e.g., an access stratum protocol stack), one or more protocol layers or protocol sub-layers above a reference protocol layer or a reference protocol sub-layer. For example, if the reference protocol layer or the reference protocol sub-layer is a physical layer (also referred to as “Layer 1”), “higher layer” may refer to a Medium Access Control (MAC) layer, and/or a Radio Link Control (RLC) layer, and/or a Packet Data Convergence Protocol (PDCP) layer, and/or a PC5-RRC (Radio Resource Control) layer, and/or a PC5-S layer, and/or an RRC layer, and/or another protocol layer or protocol sub-layer. Unless otherwise specified, the reference protocol layer or the reference protocol sub-layer is a physical layer. A “higher layer” may also be referred to as a “high layer” if this causes no ambiguity.
“Signaling” may refer to signaling of a physical layer, or signaling of a higher layer.
“Configure” may mean that in a communication node (e.g., a UE), a protocol layer (e.g., an RRC layer) entity provides configuration information to an entity of another protocol layer (e.g., a physical layer).
“Configure” may mean that a protocol layer (e.g., an RRC layer) entity of a communication node (e.g., a base station) provides configuration information to a peer protocol layer entity of another communication node (e.g., a UE) (for example, transmission, from the base station to the UE, of RRC signaling in which the configuration information is included, or transmission, from a UE-A to a UE-B, of PC5-RRC signaling in which the configuration information is included).
“Pre-configure” may mean that corresponding configuration information is preset in a specific storage location in a communication node (e.g., a UE), or corresponding configuration information is preset in a specific storage location accessible by a UE.
“(Pre-)configure” may refer to “configure or pre-configure”.
“Number” may refer to “total number”. For example, “the number of subchannels in a resource pool” may refer to the total number of subchannels in the resource pool.
A sequence “a₀, a₁, . . . , a_{N-1}” may be used to represent a case in which N is greater than or equal to 1. For example, N=1; accordingly, the sequence is a₀. As another example, N=2; accordingly, the sequence is a₀, a₁.
Elements in a time sequence (e.g., denoted as t₀, t₁, . . . , t_{N-1}) or a corresponding set (e.g., denoted as {t₀, t₁, . . . , t_{N-1}}) may appear in chronological order, for example, a time corresponding to t₀ is earlier than (or not later than) a time corresponding to t₁, a time corresponding to t₁ is earlier than (or not later than) a time corresponding to t₂, etc.
μ may represent a subcarrier spacing configuration, for example μ=0. Δf may represent a corresponding subcarrier spacing (SCS). For example, μ=0 corresponds to Δf=15 kHz.
A “symbol” may refer to an Orthogonal Frequency Division Multiplexing (OFDM) symbol.
A resource may correspond to one or a plurality of the following:
   One or more parameters in a time-domain. For example, a starting symbol of the resource, a starting slot of the resource, the number of symbols occupied by the resource, or the number of slots occupied by the resource.
   One or more parameters in a frequency-domain. For example, a starting sub-channel of the resource, a starting resource block (RB) of the resource, a starting subcarrier of the resource, the number of sub-channels occupied by the resource, the number of RBs occupied by the resource, or the number of subcarriers occupied by the resource.
   One or more parameters in a code-domain. For example, a cyclic shift value corresponding to the resource or a corresponding cyclic shift index, or a cyclic shift pair value corresponding to the resource or a corresponding cyclic shift pair index.
   One or more parameters in a spatial-domain. For example, a layer corresponding to the resource, wherein a “layer” may refer to a Multiple Input Multiple Output (MIMO) layer.
A “layer” may refer to one of one or more layers to which a Transport Block (TB) is mapped in spatial multiplexing. The mapping may also be considered as a mapping of a codeword corresponding to the TB to the one or more layers.
An “RB” may refer to a Physical Resource Block (PRB), a Virtual Resource Block (VRB), a common resource block (CRB), or an Interlaced Resource Block (IRB).
“Numbering” and “indexing” are interchangeable. For example, the number of an RB may also be referred to as the index of the RB. As another example, “numbering an RB as 0” may also be expressed as “indexing an RB as 0”.
An RB represented by a CRB number may also be represented by a corresponding PRB number, and vice versa.
The numbering of elements in a sequence (or an array, or a list, or an ordered set, or the like) may start from 0. For example, the first RB of an RB set may be referred to as RB 0 of the RB set.
An object (e.g., a subcarrier, a slot, a cyclic shift, etc.) may be represented by an index thereof, wherein the index may be an index within a set. For example, in the set of RBs

$${A}_{CRB}^{ref} = \{ {a}_{0}^{ref} , {a}_{1}^{ref} , {a}_{2}^{ref} , {a}_{3}^{ref} , {a}_{4}^{ref} \} ,$$

the index of

$${a}_{0}^{ref}$$

is 0.
In signaling, an object may be indicated by means of the index of the object.
If an object is mentioned without a number thereof being specified, then the number of the object may be singular or plural. For example, in the expression “performing transmission(s) on a channel”, the “transmission(s)” may correspond to one transmission, or a plurality of transmissions.
Δ(x₁,x₂) may represent an offset between x₁ and x₂, wherein x₁ and x₂ may be two parameters (or variables) that can be compared, or two possible values of one parameter (or variable) (e.g., x₁ and x₂ may be two slots, or two sub-frames, or two frames, or two subcarriers, or two RBs, or two sub-channels, etc.).
Δ(x₁,x₂) may be equal to x₂−x₁. For example, a CRB set is denoted as

$${A}_{CRB}^{ref} = \{ {a}_{0}^{ref} , {a}_{1}^{ref} , {a}_{2}^{ref} , {a}_{3}^{ref} , {a}_{4}^{ref} \} ,$$

wherein

$${a}_{0}^{r e f} = 5 , {a}_{1}^{r e f} = 15 , {a}_{2}^{r e f} = 25 , {a}_{3}^{r e f} = 35 and {a}_{4}^{r e f} = 45 , and$$

$${x}_{1} = {a}_{0}^{r e f} and {x}_{2} = {a}_{3}^{r e f} ,$$

then Δ(x₁, x₂) may be equal to

$${a}_{3}^{ref} - {a}_{0}^{ref} = 35 - 5 = 30 .$$

Δ(x₁, x₂) may be equal to idx(x₂)−idx(x₁), wherein idx(x₁) and idx(x₂) are indexes of elements corresponding to x₁ and x₂ in the same set, respectively. For example, a CRB set is denoted as

$${A}_{C R B}^{r e f} = \{ {a}_{0}^{r e f} , {a}_{1}^{r e f} , {a}_{2}^{r e f} , {a}_{3}^{r e f} , {a}_{4}^{r e f} \} ,$$

wherein

$${a}_{0}^{r e f} = 5 , {a}_{1}^{r e f} = 15 , {a}_{2}^{r e f} = 25 , {a}_{3}^{r e f} = 35 and {a}_{4}^{r e f} = 45 , and$$

$${x}_{1} = {a}_{0}^{r e f} and {x}_{2} = {a}_{3}^{r e f} ,$$

then Δ(x₁, x₂) may be equal to 3−0=3.
The “offset between x₁ and x₂” may also be referred to as an offset of x₂ with respect to x₁ or an offset of x₂ relative to x₁.
The “offset between x₁ and x₂” may also be referred to as an offset from x₁ to x₂.
If Δ(x₁, x₂)=D, then x₂ may be denoted as x₂=ADD (x₁, D).
If Δ(x₁, x₂)=D, then x₁ may be denoted as x₁=SUBTRACT (x₂, D).
An offset between two subcarriers may be an offset between the center frequencies of the two subcarriers.
A modulo operation may be defined as r∝a mod N, wherein
   r is a remainder;
   a=N×q+r, wherein q=└a/N┘. q may be referred to as an integer quotient of a and N.
0≤r<|N|.
A round operation may be denoted as b=round(a), wherein b may be defined as the integer closest to a. If there are two integers closest to a, b may be defined as the larger of the two integers, or as the smaller of the two integers.
Sidelink control information (SCI) may refer to 1^{st}-stage SCI and/or 2^{nd}-stage SCI.
SL refers to NR SL.
“Sidelink” may refer to NR sidelink.
“Carrier” may refer to a sidelink carrier.
“Bandwidth part” may refer to a sidelink bandwidth part.
“Resource pool” may refer to a sidelink resource pool.
A “sidelink slot” may refer to a slot (pre-)configured with a sidelink resource (e.g., a slot in a resource pool). The “sidelink resource” may or may not include a resource for a specific purpose. The “resource for a specific purpose” may be a resource for a synchronization procedure, for example, a resource for transmitting an S-SS/Physical Sidelink Broadcast Channel or Sidelink-Synchronization Signal/Physical Sidelink Broadcast Channel (S-SS/PSBCH) block.
A “physical slot” may refer to a slot belonging to a certain set of physical slots, wherein the set of physical slots may be all of the slots in a continuous period of time (e.g., a frame period having a duration of 1024 frames). Physical slots in the set of physical slots may be sequentially numbered as 0, 1, . . . in chronological order.
A “logical slot” may refer to a slot belonging to a set of slots of a certain resource pool, where the set of slots may be all of the slots belonging to the resource pool in a continuous period of time (e.g., a frame period having a duration of 1024 frames); logical slots in the set of slots may be sequentially numbered as 0, 1, . . . in chronological order.
A “logical slot” may refer to a slot that may be configured to belong to a set of slots of a certain resource pool.
An offset (Δ(x₁, x₂) between slot x₁ and slot x₂ may be an offset between physical slots respectively corresponding to the slot x₁ and the slot x₂, or is an offset between logical slots respectively corresponding to the slot x₁ and the slot x₂.
A “sidelink slot” may refer to a slot that belongs to a set of slots of a certain resource pool.
A “sidelink slot” may refer to a slot that may be (pre-)configured to belong to a set of slots of a certain resource pool.
A sidelink transmission which multiplexes a Physical Sidelink Shared Channel (PSSCH) and a Physical Sidelink Control Channel (PSCCH) associated therewith in the same resource (e.g., a number of contiguous symbols in a sidelink slot in a time-domain, and a number of contiguous sub-channels in a frequency-domain) may be referred to as a “PSCCH/PSSCH transmission”.
In a time-domain, a “frame” (or referred to as a “radio frame”) may be a system frame or a direct frame. A frame number period (e.g., denoted as T_{FNP}) may be a value of a pre-defined or (pre-)configured parameter, or may be determined according to a value of one or more pre-defined or (pre-)configured parameters, e.g., T_{FNP}=1024 frames. The duration of each frame may be T_{f}=10 milliseconds, in which 10 subframes may be included, wherein the duration of each subframe is T_{sf}=1 millisecond. Each subframe may include

$${N}_{slot}^{s u b f r ame , μ}$$

slots, e.g.,

$${N}_{slot}^{s u b f r a m e μ} = {2}^{μ} .$$

The index of a slot in a subframe may be denoted as

$${n}_{s}^{μ} ( {n}_{s}^{μ} ∈ \{ 0 , 1 , … , {N}_{slot}^{s u b f r ame , μ} - 1 \} ) .$$

The index of a slot in a frame may be denoted as

$${n}_{s , f}^{μ} ( {n}_{s , f}^{μ} ∈ \{ 0 , 1 , … , {N}_{slot}^{f r ame , μ} - 1 \} ) ,$$

wherein

$${N}_{slot}^{f r ame , μ}$$

may ne equal to 10·2^{μ}. The index pf a slot in a frame number period may be denoted as

$${n}_{s , f , p}^{μ} ( {n}_{s , f , p}^{μ} ∈ \{ 0 , 1 , … , {N}_{slot}^{FNP , μ} - 1 \} ) ,$$

wherein

$${N}_{slot}^{FNP , μ}$$

may be equal to

$${T}_{FNP} \cdot {N}_{slot}^{frame , μ}$$

(e.g., 1024·(10·2^{μ})).
“Sidelink grant” may refer to “sidelink dynamic grant” or “sidelink configured grant”.
“Sidelink dynamic grant” and “dynamic sidelink grant” are interchangeable.
“Sidelink configured grant” and “configured sidelink grant” are interchangeable.
“Type 1 sidelink configured grant” and “sidelink configured grant type 1” are interchangeable.
“Type 2 sidelink configured grant” and “sidelink configured grant type 2” are interchangeable.
“Channel” refers to a shared spectrum channel. For example, a shared spectrum channel having a bandwidth of 20 MHz on which a “channel access procedure” may be performed.
“Physical Sidelink Feedback Channel (PSFCH) resource” (PSFCH resource) may be replaced with “PSFCH transmission resource” or “PSFCH transmission occasion resource”.
A sidelink ID (sidelink identity, SL ID) may be a layer 1 sidelink ID or a layer 2 sidelink ID.
A priority (or priority level) may correspond to a priority value. For example, one priority corresponds to a priority value of 0, and another priority corresponds to a priority value of 1.
A priority may correspond to a priority value in one or more protocol layers (or protocol sublayers), wherein corresponding priority values in different protocol layers (or protocol sublayers) may be equal or unequal. For example, a priority may correspond to a priority value of 0 at a physical layer, and a priority value of 1 at a higher layer. As another example, another priority may correspond to a priority value of 1 at a physical layer, and a priority value of 2 at a higher layer.
The relationship between the priority order and the corresponding priority value may be that: as the priority value increases, the priority (or referred to as “priority order”) decreases. For example, if priority values corresponding to priorities associated with a first sidelink transmission and a second sidelink transmission are 0 and 1, respectively, then the priority of the first sidelink transmission is higher than the priority of the second sidelink transmission.
The relationship between the priority order and the corresponding priority value may be that: as the priority value increases, the priority (or referred to as “priority order”) increases. For example, if priority values corresponding to priorities associated with a first sidelink transmission and a second sidelink transmission are 0 and 1, respectively, then the priority of the first sidelink transmission is lower than the priority of the second sidelink transmission.

5G is capable of operating in both a licensed spectrum (e.g., part or all of 3300 MHz to 3800 MHz) and an unlicensed spectrum (e.g., part or all of 5150 MHz to 5925 MHz, or part or all of 5925 MHz to 7125 MHz, or part or all of 5925 MHz to 6425 MHz).

For an unlicensed spectrum, a node that supports 5G may perform an “operation with shared spectrum channel access”, for example, a “channel access procedure” (also referred to as single-channel access procedure, or referred to as channel access procedure for transmission(s) on a single channel) is performed on a “shared-spectrum channel” (also referred to as “channel” for short), or a “multi-channel access procedure” (also referred to as a channel access procedure for transmission(s) on multiple channels) is performed on a plurality of shared spectrum channels, so as to assess whether part or all of the corresponding one or more shared spectrum channels can be used to perform (one or more) transmission(s) (e.g., downlink transmission, uplink transmission, or sidelink transmission), wherein one shared spectrum channel may include a number of contiguous RBs. In the present invention, unless otherwise specified, a “channel access procedure” (or “channel access”) may correspond to a channel access procedure for single-channel transmission or a channel access procedure for multi-channel transmission. A result of a channel access procedure may be “success” (also referred to as “channel access success”) or “failure” (also referred to as “channel access failure”).

A shared spectrum channel may correspond to a carrier, or part of the carrier. For example, one shared spectrum channel may correspond to one carrier having a bandwidth of 20 MHz; as another example, one shared spectrum channel may correspond to the lower-frequency 20-MHz portion of one carrier having a bandwidth of 40 MHz, and another shared spectrum channel may correspond to the other 20-MHz portion (i.e., the higher-frequency 20-MHz portion) of the same carrier.

The operation of assessing whether the one or more shared spectrum channels can be used to perform one or more transmission(s) may be referred to as Clear Channel Assessment (CCA). Such a mechanism of performing CCA before using one or more shared spectrum channels may be referred to as LBT, and accordingly, each of the one or more shared spectrum channels may be referred to as an “LBT (Listen Before Talk) channel”, and accordingly, “channel access success” may be referred to as “LBT success”, and “channel access failure” may be referred to as “LBT failure”. Whether a communication node needs to perform CCA (also referred to as “needs to perform LBT”), and a specific procedure of the CCA, may be related to the regulations of the country and/or region in which the communication node is located.

One or more “sensing” operations may be performed on a channel during channel access, wherein the state of the channel (e.g., “busy”; or, e.g., “idle”) may be determined in each sensing operation. For example, within a sensing slot duration Tₛₗ, if a duration in which power detected on the channel (e.g., denoted as X_{detected}) is less than (or, less than or equal to) a power detection threshold (e.g., denoted as Xₜₕᵣₑₛₕ) is at least T_{sl,thresh}, then it can be considered that the channel is idle within the sensing slot durationTₛₗ; otherwise, it can be considered that the channel is busy within the sensing slot durationTₛₗ. T_{sl,thresh} may be a pre-defined or configured value, e.g., T_{sl,thresh}=4 μs. The sensing slot duration Tₛₗ may be a pre-defined or configured value, e.g., Tₛₗ=9 μs.

In a channel access procedure for single-channel transmission performed for one or more intended transmissions, whether part or all of the one or more intended transmissions can be performed can be determined, and/or the result of the single-channel access procedure can be determined, on the basis of one or more “sensing” operations on a channel (e.g., denoted as ch₀) within a first channel access duration, with the duration of each operation being a second channel access duration (e.g., this may correspond to a sensing slot duration Tₛₗ), and according to the state (e.g., “idle”; or e.g., “busy”) of the channel ch₀ determined in each “sensing” operation. For example, if, within the first channel access duration, the number of times which the channel ch₀ is consecutively determined to be “idle” reaches (or exceeds) a pre-defined or configured threshold, then the one or more intended transmissions may be performed, and/or the channel ch₀ may be considered to have been successfully accessed (correspondingly, the result of the channel access procedure is “success”, also referred to as “channel access success”, and also referred to as “LBT success”); otherwise, the one or more intended transmissions cannot be performed, and/or it may be considered that the channel ch₀ cannot be accessed (correspondingly, the result of the channel access procedure is “failure”, also referred to as “channel access failure”, and also referred to as “LBT failure”).

In a channel access procedure for multi-channel transmission performed for one or more intended transmissions, channel access may be performed on part or all of the channels in a set of channels, respectively, and according to channel access result(s) corresponding to one or more of the channels, respectively, whether part or all of the one or more intended transmissions may be performed is determined, and/or the result of the multi-channel access procedure is determined (e.g., the result may be “success”, also referred to as “channel access success”, and also referred to as “LBT success”; or, the result may be “failure”, also referred to as “channel access failure”, and also referred to as “LBT failure”).

After a channel access procedure is performed, (one or more) transmissions performed on the corresponding (one or more) channel(s) may be referred to as “channel occupancy” (CO), and a corresponding duration may be referred to as a “channel occupancy time” (COT). A COT may be shared between one or more communication nodes, and accordingly, the time corresponding to the COT may include the duration of (one or more) transmissions performed by the one or more communication nodes on the corresponding (one or more) channels, and optionally, the time corresponding to a transmission gap between the transmissions (e.g., when the duration of the transmission gap is less than or equal to 25 us). A COT may not exceed a pre-defined or configured maximum value (e.g., referred to as a maximum COT, or simply referred to as a MCOT).

In a sidelink slot (e.g., denoted as

$${t}_{i}^{e , j} )$$

in a resource pool (e.g., denoted as eⱼ), Q “starting sidelink symbols” (or “candidate starting sidelink symbols”) may be defined or (pre-)configured or determined, wherein Q may be a pre-defined or (pre-)configured or otherwise determined integer (e.g., Q=1; or Q=2). An index of each starting sidelink symbol in the sidelink slot

$${t}_{i}^{e , j}$$

may be recorded in chronological order as

$${n}_{0}^{Q} , {n}_{1}^{Q} , … , and {n}_{Q - 1}^{Q}$$

sequentially.

$${n}_{0}^{Q} , {n}_{1}^{Q} , … , and {n}_{Q - 1}^{Q}$$

may be referred to as a “first starting sidelink symbol”, a “second starting sidelink symbol”, . . . , and a “Qth starting sidelink symbol” in the sidelink slot

$${t}_{i}^{e , j} ,$$

respectively.

For q∈{0, 1, . . . , Q−1}, the starting sidelink symbol

$${n}_{q}^{Q}$$

may correspond to a set

$${L}_{q}^{SL , Q} = \{ {l}_{0}^{SL , Q , q} , {l}_{1}^{SL , Q , q} , … , {l}_{{N}_{q}^{SLQ} - 1}^{SL , Q , q} \}$$

consisting of

$${N}_{q}^{SL , Q}$$

sidelink symbols in the sidelink slot

$${t}_{i}^{e , j} ,$$

wherein

$${l}_{0}^{SL , Q , q} , {l}_{1}^{SL , Q , q} , … , and {l}_{{N}_{q}^{SL , Q} - 1}^{SL , Q , q}$$

may represent indexes of corresponding symbols in the sidelink slot

$${t}_{i}^{e , j} ; {l}_{0}^{SL , Q , q}$$

may correspond to the starting sidelink symbol

$${n}_{q}^{Q} , i . e . , {l}_{0}^{SL , Q , q} = {n}_{q}^{Q} ;$$

symbols in the set

$${L}_{q}^{SL , Q}$$

may be contiguous symbols, e.g.,

$${l}_{1}^{SL , Q , q} = {l}_{0}^{SL , Q , q} + 1 , {l}_{2}^{SL , Q , 2} = {l}_{0}^{SL , Q , q} + 2 , … , \\ and {l}_{{N}_{q}^{SL , Q} - 1}^{SL , Q , q} = {l}_{0}^{SL , Q , q} + {N}_{q}^{SL , Q} - 1 ; {l}_{0}^{SL , Q , q}$$

may correspond to a symbol

$${l}_{start}^{SL , Q , q} , i . e . , {l}_{0}^{SL , Q , q} = {l}_{start}^{SL , Q , q} ;$$

the symbol

$${l}_{start}^{SL , Q , q}$$

and the symbol

$${n}_{q}^{Q}$$

may be the same symbol, i.e.,

$${l}_{start}^{SL , Q , q} = {n}_{q}^{Q} .$$

A slot including one starting sidelink symbol (i.e., Q=1) may be referred to as a “type 1 sidelink slot”. In a type 1 sidelink slot,

$${n}_{0}^{1} ( i . e . , {n}_{q}^{Q}$$

corresponding to Q=1 and q=0) may be a value of a predefined or (pre-)configured parameter, or may be determined according to a value of one or more pre-defined or (pre-)configured parameters, for example,

$${n}_{0}^{1}$$

may be configured using a parameter sl-StartSymbol; as another example,

$${n}_{0}^{1}$$

may be configured using a parameter sl-1 st-StartSymbol.

$${l}_{start}^{SL , 1 , 0} ( i . e . , {l}_{start}^{SL , Q , q}$$

corresponding to Q=1 and q=0) may be a value of a pre-defined or (pre-)configured parameter, or may be determined according to a value of one or more pre-defined or (pre-)configured parameters, for example,

$${l}_{start}^{SL , 1 , 0}$$

may be configured using the parameter sl-StartSymbol; as another example,

$${l}_{start}^{SL , 1 , 0}$$

may be configured using the parameter sl-1st-StartSymbol.

$${N}_{0}^{SL , 1} ( i . e . , {N}_{q}^{SL , Q}$$

corresponding to Q=1 and q=0) may be a value of a pre-defined or (pre-)configured parameter, or may be determined according to a value of one or more pre-defined or (pre-)configured parameters, for example,

$${N}_{0}^{SL , 1}$$

may be configured using a parameter sl-LengthSymbols; as another example,

$${N}_{0}^{SL , 1}$$

may be configured using a parameter sl-1st-LengthSymbols.

A slot including two starting sidelink symbols (i.e., Q=2) may be referred to as a “type 2 sidelink slot”. In a type 2 sidelink slot,

$${n}_{0}^{2} ( i . e . , {n}_{q}^{Q}$$

corresponding to Q=2 and q=0) may be a value of a pre-defined or (pre-)configured parameter, or may be determined according to a value of one or more pre-defined or (pre-)configured parameters, for example,

$${n}_{0}^{2}$$

may be configured using the parameter sl-StartSymbol; as another example,

$${n}_{0}^{2}$$

may be configured using parameter sl-1 st-StartSymbol.

$${n}_{0}^{2}$$

may be determined according to

$${n}_{0}^{1} and / or {l}_{start}^{SL , 1 , 0} .$$

For example,

$${n}_{0}^{2} = {n}_{0}^{1} ;$$

as another example,

$${n}_{0}^{2} = {l}_{start}^{SL , 1 , 0} .$$

$${l}_{start}^{SL , 2 , 0} ( i . e . , {l}_{start}^{SL , Q , q}$$

corresponding to Q=2 and q=0) may be a value of a pre-defined or (pre-)configured parameter, or may be determined according to a value of one or more pre-defined or (pre-)configured parameters, for example,

$${l}_{start}^{SL , 2 , 0}$$

may be configured using the parameter sl-StartSymbol; as another example,

$${l}_{start}^{SL , 2 , 0}$$

may be configured using the parameter sl-1st-StartSymbol.

$${l}_{start}^{SL , 2 , 0}$$

may be determined according to

$${n}_{0}^{1} and / or {l}_{start}^{SL , 1 , 0} .$$

For example,

$${l}_{start}^{SL , 2 , 0} = {n}_{0}^{1} ;$$

as another example,

$${l}_{start}^{SL , 2 , 0} = {l}_{start}^{SL , 1 , 0} .$$

$${N}_{0}^{SL , 2} ( i . e . , {N}_{q}^{SL , Q}$$

corresponding to Q=2 and q=0) may be value of a pre-defined or (pre-)configured parameter, or may be determined according to a value of one or more pre-defined or (pre-)configured parameters, for example,

$${N}_{0}^{SL , 2}$$

may be configured using the parameter sl-LengthSymbols; as another example,

$${N}_{0}^{SL , 2}$$

may be configured using the parameter sl-1st-LengthSymbols.

$${N}_{0}^{SL , 2}$$

may be determined according to one or more of

$${N}_{0}^{SL , 1} , {n}_{0}^{1} , {n}_{0}^{2} , {l}_{start}^{SL , 1 , 0} , and {l}_{start}^{SL , 2 , 0} .$$

For example,

$${N}_{0}^{SL , 2} = {N}_{0}^{SL , 1} - ( {n}_{0}^{2} - {n}_{0}^{1} ) ;$$

as another example,

$${N}_{0}^{SL , 2} = {N}_{0}^{SL , 1} - ( {l}_{start}^{SL , 2 , 0} - {l}_{start}^{SL , 1 , 0} ) .$$

$${n}_{1}^{2} ( i . e . , {n}_{q}^{Q}$$

corresponding to Q=2 and q=1) may be value of a pre-defined or (pre-)configured parameter, or may be determined according to a value of one or more pre-defined or (pre-)configured parameters, for example,

$${n}_{1}^{2}$$

may be configured using a parameter sl-2nd-StartSymbol;

$${l}_{s t a r t}^{SL , 2 , 1} ( i . e . , {l}_{s t a r t}^{SL , Q , q}$$

corresponding to Q=2 and q=1) may be value of a pre-defined or (pre-)configured parameter, or may be determined according to a value of one or more pre-defined or (pre-)configured parameters, for example,

$${l}_{s t a r t}^{SL , 2 , 1}$$

may be configured using the parameter sl-2nd-StartSymbol;

$${N}_{1}^{S L , 2} ( i . e . , {N}_{q}^{S L , Q}$$

corresponding to Q=2 and q=1) may be value of a pre-defined or (pre-)configured parameter, or may be determined according to a value of one or more pre-defined or (pre-)configured parameters, for example,

$${N}_{1}^{S L , 2}$$

may be configured using a parameter sl-2nd-LengthSymbols;

$${N}_{1}^{S L , 2}$$

may be determined according to one or more of

$${N}_{0}^{S L , 1} , {n}_{0}^{1} , {n}_{1}^{2} , {l}_{s t a r t}^{SL , 1 , 0} , and {l}_{s t a r t}^{SL , 2 , 1} .$$

For example,

$${N}_{1}^{SL , 2} = {N}_{0}^{S L , 1} - ( {n}_{1}^{2} - {n}_{0}^{1} ) ;$$

as another example,

$${N}_{1}^{S L , 2} = {N}_{0}^{S L , 1} - ( {l}_{s t a r t}^{SL , 2 , 1} - {l}_{s t a r t}^{SL , 1 , 0} ) .$$

$${N}_{1}^{S L , 2}$$

may be determined according to one or more of

$${N}_{0}^{S L , 2} , {n}_{0}^{2} , {n}_{1}^{2} , {l}_{s t a r t}^{SL , 2 , 1} , and {l}_{s t a r t}^{SL , 2 , 1} .$$

For example,

$${N}_{1}^{S L , 2} = {N}_{0}^{S L , 2} - ( {n}_{1}^{2} - {n}_{0}^{2} ) ;$$

as another example,

$${N}_{1}^{S L , 2} = {N}_{0}^{S L , 2} - ( {l}_{s t a r t}^{SL , 2 , 1} - {l}_{s t a r t}^{SL , 2 , 0} ) .$$

A resource pool may include zero, one, or more type 1 sidelink slots, and zero, one, or more type 2 sidelink slots.

A bandwidth part may include zero, one, or more resource pools including only type 1 sidelink slots, zero, one, or more resource pools including only type 2 sidelink slots, and zero, one, or more resource pools including both type 1 and type 2 sidelink slots.

Q=2 may correspond to a function of supporting two starting sidelink symbols in one sidelink slot (or simply referred to as a “two starting sidelink symbols” function). For example, part or all of slots in a resource pool with the “two starting sidelink symbols” function enabled may be type 2 sidelink slots. As another example, part or all of slots in part or all of resource pools in a bandwidth part with the “two starting sidelink symbols” function enabled may be type 2 sidelink slots. As another example, a resource pool with the “two starting sidelink symbols” function disabled does not include any type 2 sidelink slot. As another example, any resource pool in a bandwidth part with the “two starting sidelink symbols” function disabled does not include any type 2 sidelink slot.

The “two starting sidelink symbols” function may be applicable to an unlicensed spectrum. For example, in an operation with shared spectrum channel access on an unlicensed spectrum, two starting sidelink symbols may be configured for one or more resource pools (or one or more slots in a resource pool). Accordingly, in a slot including two starting sidelink symbols, a UE may determine an appropriate starting sidelink symbol according to actual time of successful channel access (e.g., one of two starting sidelink symbols in a slot that is closer to the time of successful channel access) and perform corresponding sidelink transmission(s), thereby reducing a probability of losing obtained COT before start of the sidelink transmission(s).

In the resource pool eⱼ (or a corresponding bandwidth part), the “two starting sidelink symbols” function may be enabled (or disabled, or configured) according to one or more parameters. For example, if the resource pool eⱼ (or the corresponding bandwidth part) is configured with one or more parameters in a parameter set

$$P {A}_{T S}^{S L} ,$$

the two starting sidelink symbols” function is enabled in the resource pool eⱼ (or the corresponding bandwidth part), wherein the parameter set

$${PA}_{TS}^{SL}$$

may include one or more of the parameter sl-1st-StartSymbol, the parameter sl-1st-LengthSymbols, the parameter sl-2nd-StartSymbol, and the parameter sl-2nd-LengthSymbols.

Any one of Q,

$${n}_{0}^{1} , {l}_{s t a r t}^{SL , 1 , 0} , {N}_{0}^{S L , 1} , {n}_{0}^{2} , {l}_{s t a r t}^{SL , 2 , 0} , {N}_{0}^{S L , 2} , {n}_{1}^{2} , {l}_{s t a r t}^{SL , 2 , 1} , and {N}_{1}^{S L , 2}$$

may be separately defined or (pre-)configured or determined for each sidelink slot in the resource pool eⱼ, or defined or (pre-)configured or determined in the resource pool eⱼ and applied to part or all of slots in the resource pool eⱼ, or defined or (pre-)configured or determined in a bandwidth part in which the resource pool eⱼ is located and applied to part or all of slots in each resource pool in the bandwidth part, or defined or (pre-)configured or determined in other ways.

Any one of Q,

$${n}_{0}^{1} , {l}_{s t a r t}^{SL , 1 , 0} , {N}_{0}^{S L , 1} , {n}_{0}^{2} , {l}_{s t a r t}^{SL , 2 , 0} , {N}_{0}^{S L , 2} , {n}_{1}^{2} , {l}_{s t a r t}^{SL , 2 , 1} , and {N}_{1}^{S L , 2}$$

may be determined according to one or more of the following factors:
a PSFCH-related configuration in the resource pool eⱼ (or the corresponding bandwidth part). For example, if PSFCH (or “PSFCH resource(s)”) is configured in the sidelink slot

$${t}_{i}^{e , j} ,$$

then Q=1. As another example, if PSFCH is not configured in the side link slot

$${t}_{i}^{e , j} ,$$

then Q may be equal to 1 or equal to 2 (for example, in this case, the value of Q is determined according to another factor).
The resource pool eⱼ (or the corresponding bandwidth part) includes configuration information related to the “two starting sidelink symbols” function.

Specifically, for example, if the resource pool eⱼ (or the corresponding bandwidth part) has the “two starting sidelink symbols” function enabled, and PSFCH is not configured in the sidelink slot

$${t}_{i}^{e , j} ,$$

then Q corresponding to the sidelink slot

$${t}_{i}^{e , j}$$

is equal to 2; otherwise, Q corresponding to the sidelink slot

$${t}_{i}^{e , j}$$

is equal to 1. As another example, for Q=1, if the parameter sl-1st-StartSymbol is configured, the corresponding

$${n}_{0}^{1} and / or {l}_{start}^{SL , 1 , 0}$$

are/is determined according to the parameter sl-1st-StartSymbol. As another example, for Q=1, if the parameter sl-1 st-StartSymbol is not configured, the corresponding

$${n}_{0}^{1} and / or {l}_{start}^{SL , 1 , 0}$$

are/is determined according to the parameter sl-StartSymbol. As another example, for Q=1, if the parameter sl-1st-LengthSymbols is configured, the corresponding

$${N}_{0}^{S L , 1}$$

is determined according to the parameter sl-1st-LengthSymbols. As another example, for Q=1, if the parameter sl-1st-LengthSymbols is not configured, the corresponding

$${N}_{0}^{S L , 1}$$

is determined according to the parameter sl-LengthSymbols.

For q∈{0, 1, . . . , Q−1}, a starting sidelink symbol

$${n}_{q}^{Q}$$

may correspond to a type 1 sidelink data symbol set (e.g., denoted as

$${L}_{CS , q}^{SL , Q} )$$

in the sidelink slot

$${t}_{i}^{e , j} ,$$

wherein a type 1 sidelink data symbol may be defined as a symbol for PSCCH and PSSCH (e.g., (pre-)configured for PSCCH and PSSCH), or defined as a symbol for PSSCH (e.g., (pre-)configured for PSSCH), or defined as a symbol for PSCCH (e.g., (pre) configured for PSCCH). For example, the set

$${L}_{CS , q}^{SL , Q}$$

may be a set consisting of all type 1 sidelink data symbols in the sidelink slot

$${t}_{i}^{e , j} ,$$

starting from the starting sidelink symbol

$${n}_{q}^{Q}$$

(e.g., including the starting sidelink symbol

$${n}_{q}^{Q}$$

or not including the starting sidelink symbol

$${n}_{q}^{Q} ) .$$

A PSSCH (or PSCCH/PSSCH) transmission that occupies part or all of symbols in the set

$${L}_{CS , q}^{SL , Q}$$

(e.g., one or more pre-defined or (pre-)configured symbols in the set

$${L}_{q}^{SL , Q} )$$

may be referred to as a PSSCH (or PSCCH/PSSCH) transmission corresponding to the starting sidelink symbol

$${n}_{q}^{Q} .$$

A method for determining the set

$${A}_{CRB}^{ref} = \{ {a}_{0}^{ref} , {a}_{1}^{ref} , {a}_{2}^{ref} , {a}_{3}^{ref} , {a}_{4}^{ref} \} ,$$

may be related to q.

A method for determining the set

$${a}_{0}^{ref} = 5 , {a}_{1}^{ref} = 15 , {a}_{2}^{ref} = 25 , {a}_{3}^{ref} = 35 and$$

$${a}_{4}^{ref} = 45 , and {x}_{1} = {a}_{0}^{ref} and {x}_{2} = {a}_{3}^{ref} ,$$

may be unrelated to q. For example, for Q=2, q₁=0, and q₂=1,

$${A}_{CRB}^{ref} = \{ {a}_{0}^{ref} , {a}_{1}^{ref} , {a}_{2}^{ref} , {a}_{3}^{ref} , {a}_{4}^{ref} \} ,$$

may always be equal to

$${L}_{CS , {q}_{2}}^{SL , Q} .$$

A method for determining the set

$${L}_{CS , q}^{SL , Q}$$

may be related to Q.

A method for determining the set

$${L}_{CS , q}^{SL , Q}$$

may be unrelated to v. For example, for Q₁=1, Q₂=2, and q=0,

$${L}_{CS , q}^{SL , {Q}_{1}}$$

may always be equal to

$${L}_{CS , q}^{SL , {Q}_{2}} .$$

The set

$${L}_{CS , q}^{SL , Q}$$

may be a subset of the set

$${L}_{q}^{SL , Q} .$$

For example, for the sidelink slot

$${t}_{i}^{e , j} ,$$

the set

$${L}_{CS , q}^{SL , Q}$$

may be a set obtained by removing, from the set

$${L}_{q}^{SL , Q} .$$

zero, one, or more of the following:
The first

$${G}_{0}^{SL , Q , q}$$

symbol(s) in the set

$${L}_{q}^{SL , Q} , i . e . , {l}_{0}^{SL , Q , q} , {l}_{1}^{SL , Q , q} , … , and {l}_{{G}_{0}^{SL , Q , q} - 1}^{SL , Q , q} ,$$

wherein

$${G}_{0}^{SL , Q , q}$$

may be an integer greater than or equal to 1

$$1 ( e . g . , {G}_{0}^{SL , Q , q} = 1 ; or , {G}_{0}^{SL , Q , q} = 2 ; or , {G}_{0}^{SL , Q , q} = 3 ; or , {G}_{0}^{SL , Q , q} = 4 ; or , {G}_{0}^{SL , Q , q} = 5 ; or , {G}_{0}^{SL , Q , q} = 6 ; or , {G}_{0}^{SL , Q , q} = 7 ) . {G}_{0}^{SL , Q , q}$$

$${G}_{0}^{SL , Q , q}$$

may be a value of a pre-defined or (pre-)configured parameter, or may be determined according to a value of one or more pre-defined or (pre-)configured parameters. For example, for

$${G}_{0}^{SL , Q , q} = 1$$

“the first

$${G}_{0}^{SL , Q , q}$$

symbol(s) in the set

$${L}_{q}^{SL , Q , ,}$$

refer to symbol

$${l}_{0}^{SL , Q , q} .$$

One or more symbols for PSFCH (if PSFCH is configured in the sidelink slot

$${t}_{i}^{e , j} ) ,$$

e.g., one or more of the following:
   a second PSFCH symbol (e.g., denoted as

$${l}_{F , 2}^{SL , Q , q} ) .$$

For example,

$${l}_{F , 2}^{SL , Q , q} = {l}_{0}^{SL , Q , q} + {N}_{q}^{SL , Q} - 2 ;$$

as another example,

$${l}_{F , 2}^{SL , Q , q} = {l}_{{N}_{q}^{SL , Q} - 1}^{SL , Q , q} - 1.$$

A first PSFCH symbol (e.g., denoted as

$${l}_{F , 1}^{SL , Q , q} ) .$$

For example,

$${l}_{F , 1}^{SL , Q , q} = {l}_{F , 2}^{SL , Q , q} - 1.$$

One or more type 1 sidelink non-data symbols, wherein a type 1 sidelink non-data symbol may be a symbol that may be used for AGC (Automatic Gain Control). A method for determining the one or more type 1 sidelink non-data symbols may be related to Q and/or q. For example, the one or more type 1 sidelink non-data symbols may include one or more of the following:
   A symbol

$${l}_{0}^{S L , Q , q} .$$

For example, this may be applied to a case where Q=2 in the sidelink slot

$${t}_{i}^{e , j} .$$

As another example, this may be applied to a case where Q=1 in the sidelink slot

$${t}_{i}^{e , j} .$$

A symbol

$${l}_{0}^{SL , 2 , 0}$$

(i.e., a symbol

$${l}_{0}^{S L , Q , q}$$

corresponding to Q=2 and q=0). For example, this may be applied to a case where Q=2 in the sidelink slot

$${t}_{i}^{e , j} .$$

A symbol

$${l}_{0}^{SL , 2 , 1}$$

(i.e., a symbol

$${l}_{0}^{S L , Q , q}$$

corresponding to Q=2 abd q=1). For example, this may be applied to a case where Q=2 in the sidelink slot

$${t}_{i}^{e , j} .$$

One or more type 2 sidelink non-data symbols, wherein a type 2 sidelink non-data symbol may be a symbol that may be used as a guard symbol; a type 2 sidelink non-data symbol may be used for transitions from reception to transmission and/or from transmission to reception. A method for determining the one or more type 2 sidelink non-data symbols may be related to Q and/or q. For example, the one or more type 2 sidelink non-data symbols may include one or more of the following:
   A symbol

$${l}_{{N}_{q}^{SL , Q} - 1}^{SL , Q , q} .$$

For example, this may be applied to a case where Q=2 in the sidelink slot

$${t}_{i}^{e , j} .$$

As another example, this may be applied to a case where Q=1 in the sidelink slot

$${t}_{i}^{e , j} .$$

A previous symbol of the first PSFCH symbol

$${l}_{F , 1}^{SL , Q , q}$$

(if PSFCH is configured in the sidelink slot

$${t}_{i}^{e , j} ) ,$$

for example, symbol

$${l}_{F , 1}^{SL , Q , q} - 1 .$$

For q∈{0, 1, . . . , Q−1}, the starting sidelink symbol

$${n}_{q}^{Q}$$

may correspond to a type 1 sidelink measurement symbol set (e.g., denoted as

$${L}_{ME , q}^{SL , Q} )$$

in the sidelink slot

$${t}_{i}^{e , j} ,$$

wherein a type 1 sidelink measurement symbol may be used for one or more types of sidelink measurement, such as sidelink CBR (sidelink channel busy ratio, SL CBR) measurement, or sidelink RSSI (sidelink received signal strength indicator, SL RSSI) measurement. For example, the set

$${L}_{ME , q}^{SL , Q}$$

may be a set consisting of all type 1 sidelink measurement symbols in the set

$${L}_{CS , q}^{SL , Q} .$$

A method for determining the set

$${L}_{ME , q}^{SL , Q}$$

may be related to q.

A method for determining the set

$${L}_{ME , q}^{SL , Q}$$

may be unrelated to q. For example, for Q=2, q₁=0, and q₂=1,

$${L}_{ME , {q}_{1}}^{SL , Q}$$

may always be equal to

$${L}_{ME , {q}_{2}}^{SL , Q} .$$

A method for determining the set

$${L}_{ME , q}^{SL , Q}$$

may be related to Q.

A method for determining the set

$${L}_{ME , q}^{SL , Q}$$

may be unrelated to Q. For example, for Q₁=1, Q₂=0,

$${L}_{ME , q}^{SL , {Q}_{1}}$$

may always be equal to

$${L}_{ME , q}^{SL , {Q}_{2}} .$$

The set

$${L}_{ME , q}^{SL , Q}$$

may be a subset of the set

$${L}_{CS , q}^{SL , Q} .$$

For example, the set

$${L}_{ME , q}^{SL , Q}$$

may be a set obtained by removing, from the set

$${L}_{CS , q}^{SL , Q} ,$$

zero, one, or more the following:
the first

$${G}_{1}^{S L , Q , q}$$

symbols(s) in the set

$${L}_{CS , q}^{SL , Q} ,$$

wherein

$${G}_{1}^{S L , Q , q}$$

may be an integer greater than or equal to

$$( e . g . , {G}_{1}^{S L , Q , q} = 1 ; or , {G}_{1}^{S L , Q , q} = 2 ; or , {G}_{1}^{S L , Q , q} = 3 ; or , {G}_{1}^{S L , Q , q} = 4 ; or , {G}_{1}^{SL , Q , q} = 5 ; or , {G}_{1}^{S L , Q , q} = 6 ; or , {G}_{1}^{S L , Q , q} = 7 ) . {G}_{1}^{S L , Q , q}$$

may be a value of a pre-defined or (pre-)configured parameter, or may be determined according to a value of one or more pre-defined or (pre-)configured parameters. For example, for

$${G}_{1}^{S L , Q , q} = 1 ,$$

“the first

$${G}_{1}^{S L , Q , q}$$

symbols(s) in the set

$${L}_{CS , q}^{SL , Q} ”$$

refer to the first symbol in the set

$${L}_{CS , q}^{SL , Q} .$$

One or more symbols for PSFCH

$$( if PSFCH is configured in the sidelink slot {t}_{i}^{e , j} ) ,$$

e.g., one or more of the following:
   the second PSFCH symbol

$${l}_{F , 2}^{SL , Q , q} .$$

the first PSFCH symbol

$${l}_{F , 1}^{SL , Q , q} .$$

One or more type 1 sidelink non-data symbols, e.g., one or more of the following:
   A symbol

$${l}_{0}^{SL , Q , q} .$$

For example, this may be applied to a case where Q=2 in the sidelink slot

$${t}_{i}^{e , j} .$$

As another example, this may be applied to a case where Q=1 in the sidelink slot

$${t}_{i}^{e , j} .$$

A symbol

$${l}_{0}^{SL , 2 , 0}$$

(i.e., a symbol

$${l}_{0}^{SL , Q , q}$$

corresponding to Q=2 and q=0). For example, this may be applied to a case where Q=2 in the sidelink slot

$${t}_{i}^{e , j} .$$

As another example, this may be applied to a case where Q=2 in the sidelink slot

$${t}_{i}^{e , j} .$$

A symbol

$${l}_{0}^{SL , 2 , 1}$$

(i.e., a symbol

$${l}_{0}^{SL , Q , q}$$

corresponding to Q=2 and q=1). For example, this may be applied to a case where Q=2 in the sidelink slot

$${t}_{i}^{e , j} .$$

As another example, this may be applied to a case where Q=2 in the sidelink slot

$${t}_{i}^{e , j} .$$

One or more type 2 sidelink non-data symbols, e.g., one or more of the following:
   A symbol

$${l}_{{N}_{q}^{SL , Q} - 1}^{SL , Q , q} .$$

For example, uns may be applied to a case where Q=2. As another example, this may be applied to a case where Q=1.
A previous symbol of the first PSFCH symbol

$${I}_{F , 1}^{SL , Q , q}$$

(of PSFCH is configured in the sidelink slot

$${t}_{i}^{e , j} ) ,$$

e.g., symbol

$${I}_{F , 1}^{SL , Q , q} - 1.$$

### Embodiment 1

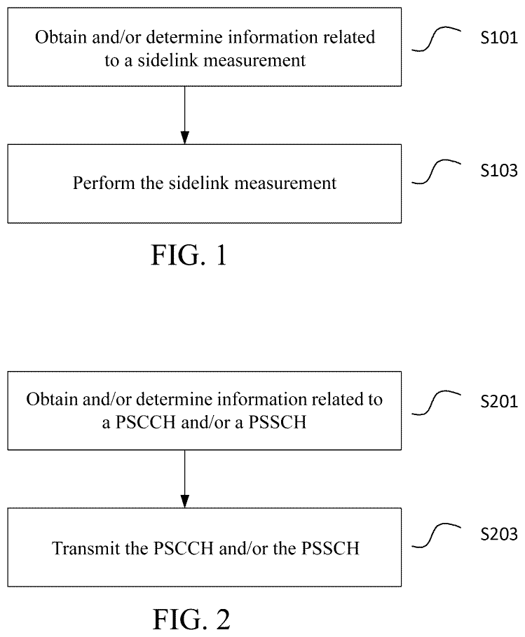

A method performed by a UE according to Embodiment 1 of the present invention will be described below with reference to FIG. 1.

FIG. 1 illustrates a flowchart corresponding to the method performed by a UE according to Embodiment 1 of the present invention.

As illustrated in FIG. 1, in Embodiment 1 of the present invention, the steps performed by the UE include: step S101 and step S103.

Specifically, in step S101, information related to a sidelink measurement (e.g., denoted as

$${Inf}_{0}^{ME} )$$

is obtained/determined.

$${Inf}_{0}^{ME}$$

may include pre-defined information and/or (pre-)configured information.

$${Inf}_{0}^{ME}$$

may include information received by the UE from another node (e.g., a base station, or another UE).

$${Inf}_{0}^{ME}$$

may include information indicated by (one or more) higher layer entities of the UE.

$${Inf}_{0}^{ME}$$

may include information of a resource pool set Eₘ (e.g., denoted as

$${N}_{m}^{E}$$

wherein

$${E}_{m} = \{ {e}_{0} , {e}_{1} , … , {e}_{{N}_{m}^{E} - 1} \} ,$$

may be an integer greater than or equal to 1).

The set Eₘ may include zero, one, or more transmission resource pools.

The set Eₘ may include zero, one, or more reception resource pools.

$${Inf}_{0}^{ME}$$

may include one or more parameters related to a sidelink CBR measurement, for example, a CBR measurement window corresponding to the sidelink CBR measurement in a slot n₀ may be defined as

$$[ {n}_{0} - {O}_{CBR , 0}^{m} , {n}_{0} - {O}_{CBR , 1}^{m} ] ,$$

wherein

$${O}_{CBR , 0}^{m}$$

may correspond to a value of a pre-defined or (pre-)configured parameter in

$${Inf}_{0}^{ME}$$

(for example,

$${O}_{CBR , 0}^{m}$$

may be equal to 100 slots; or,

$${O}_{CBR , 0}^{m}$$

may be equal to 100·2^{μ} slots), or may be determined according to a value of one or more pre-defined or (pre-)configured parameters in

$${Inf}_{0}^{ME} \cdot {O}_{CBR , 1}^{m}$$

may correspond to a value of a pre-defined or (pre-)configured parameter in

$${Inf}_{0}^{ME} ( e . g . , {O}_{CBR , 1}^{m}$$

may be equal to 1 slot), or may be determined according to a value of one or more pre-defined or (pre-)configured parameters in

$${Inf}_{0}^{ME} .$$

$${Inf}_{0}^{ME}$$

may include one or more parameters related to sidelink RSSI measurement.

Further, in step S103, sidelink measurement is performed.

The sidelink measurement may be an intra-frequency measurement or an inter-frequency measurement.

When the sidelink measurement is performed, the UE may be in one RRC state of RRC_IDLE, RRC_INACTIVE, and RRC_CONNECTED.

The sidelink measurement may include one or more sidelink RSSI measurements.

The sidelink measurement may include one or more sidelink CBR measurements, wherein one sidelink CBR measurement may correspond to one or more sidelink RSSI measurements in a corresponding CBR measurement window.

A sidelink RSSI measurement may be a measurement for a type 1 reference measurement resource (e.g., denoted as

$${r}_{i , z}^{SRI , j} )$$

in a slot (e.g., denoted as

$${t}_{i}^{e , j} )$$

in a resource poor (e.g., a resource pool eⱼ, wherein

$$j ∈ \{ 0 , 1 , … , {N}_{m}^{E} - 1 \} ) ,$$

wherein z may correspond to an index of the type 1 reference measurement resource

$${r}_{i , z}^{SRI , j}$$

in the slot

$${t}_{i}^{e , j} .$$

The sidelink RSSI may be defined as a linear average of total received power (e.g., in Watts) in the type 1 reference measurement resource. If the sidelink RSSI measurement is part of a sidelink CBR measurement, then the slot

$${t}_{i}^{e , j}$$

may be a slot in a corresponding CBR measurement window.

The type 1 reference measurement resource

$${r}_{i , z}^{SRI , j}$$

may correspond to

$${N}_{fr , i}^{SRI , j}$$

subchannels (or

$${N}_{fr , i}^{SRI , j}$$

subcarriers; or,

$${N}_{fr , i}^{SRI , j}$$

### RDs; or,

$${N}_{fr , i}^{SRI , j}$$

owner frequency units) in the frequency domain and

$${N}_{tm , i}^{SRI , j}$$

symbols in the time domain, wherein
the

$${N}_{fr , i}^{SRI , j}$$

subchannels (or

$${N}_{fr , i}^{SRI , j}$$

subcarriers; or

$${N}_{fr , i}^{SRI , j}$$

RBs; or,

$${N}_{fr , i}^{SRI , j}$$

other frequency units) may be denoted as

$${f}_{i , z , 0}^{SRI , r , j} , {f}_{i , z , 1}^{SRI , r , j} , … , {f}_{i , z , {N}_{fr , i}^{SRI , j} - 1}^{SRI , r , j} ,$$

respectively, and a corresponding set may be denoted as

$${F}_{i}^{SRI , r , j} = \{ {f}_{i , z , 0}^{SRI , r , j} , {f}_{i , z , 1}^{SRI , r , j} , … , {f}_{i , z , {N}_{fr , i}^{SRI , j} - 1}^{SRI , r , j} \} ,$$

wherein

$${N}_{fr , i}^{SRI , j}$$

may be integer greater than or equal to 1 (e.g.,

$${N}_{fr , i}^{SRI , j} = 1 ) . {N}_{fr , i}^{SRI , j}$$

may be a value of a pre-defined or (pre-)configured parameter, or may be determined according to a value of one or more pre-defined or (pre-)configured parameters, or determined in other ways.
The

$${N}_{tm , i}^{SRI , j}$$

symbols may be denoted as

$${t}_{i , 0}^{SRI , r , j} , {t}_{i , 1}^{SRI , r , j} , … , {t}_{i , {N}_{tm , i}^{SRI , j} - 1}^{SRI , r , j} ,$$

respectively, and a corresponding set may be denoted as

$${T}_{i}^{SRI , r , j} = \{ {t}_{i , 0}^{SRI , r , j} , {t}_{i , 1}^{SRI , r , j} , … , {t}_{i , {N}_{tm , i}^{SRI , j} - 1}^{SRI , r , j} \} ) ,$$

wherein

$${N}_{tm , i}^{SRI , j}$$

may be an integer greater than or equal to 1.

$${N}_{tm , i}^{SRI , j}$$

may be a value of a pre-defined or (pre-)configured parameter, or may be determined according to a value of one or more pre-defined or (pre-)configured parameter, or determined in other ways.
The

$${N}_{tm , i}^{SRI , j}$$

symbols may be

$${N}_{tm , i}^{SRI , j}$$

contiguous symbols in the slot

$${t}_{i}^{e , j} .$$

A set (e.g., denoted as

$${S}_{i}^{SRI , j} )$$

consisting of the

$${N}_{tm , i}^{SRI , j}$$

symbols may be determined according to one or more factors including the number (Q) of starting sidelink symbols in the slot

$${t}_{i}^{e , j} ,$$

for example, if Q=1 in the slot

$${t}_{i}^{e , j} ,$$

then

$${S}_{i}^{SRI , j}$$

is equal to a set

$${S}_{i , 0}^{SRI , j} ;$$

as another example, of Q=2 in the slot

$${t}_{i}^{e , j} ,$$

then

$${S}_{i}^{SRI , j}$$

is equal to a set

$${S}_{i , 1}^{SRI , j} .$$

The set

$${S}_{i , 0}^{SRI , j}$$

may be equal to a set

$${L}_{ME , 0}^{SL , 1}$$

in the slot

$${t}_{i}^{e , j}$$

(i.e., a type 1 sidelink measurement symbol set

$${L}_{ME , 0}^{SL , Q}$$

corresponding to Q=1 and q=0).

The set

$${s}_{i , 1}^{SRI , j}$$

may be determined according to one or more factors including a set

$${L}_{ME , 1}^{SL , 2}$$

in the slot

$${t}_{i}^{e , j}$$

(i.e., a type 1 sidelink measurement symbol set

$${L}_{ME , q}^{SL , 2}$$

corresponding to Q=2 and q=1) and/or a set

$${L}_{ME , 0}^{SL , 2}$$

in the slot

$${t}_{i}^{e , j}$$

(i.e., a type 1 sidelink measurement symbols set

$${L}_{ME , q}^{SL , Q}$$

corresponding to Q=2 and q=0). For example,

$${S}_{i , 1}^{SRI , j} = {L}_{ME , 1}^{SL , 2} ;$$

$$or ,$$

$${S}_{i , 1}^{SRI , j} = {L}_{ME , 0}^{SL , 2} ;$$

$$or ,$$

$${S}_{i , 1}^{SRI , j} = {L}_{ME , 1}^{SL , 2} ⋂ {L}_{ME , 0}^{SL , 2} ;$$

$$or ,$$

$${S}_{i , 1}^{SRI , j} = {L}_{ME , 1}^{SL , 2} ⋃ {L}_{ME , 0}^{SL , 2} .$$

Embodiment 1 of the present invention may be performed by a physical layer entity of the UE.

In Embodiment 1 of the present invention, an operation related to Q=2 (e.g., an operation related to determining the set

$${S}_{i , 1}^{SRI , j} )$$

may be applied to operations with shared spectrum channel access (e.g., operations with shared spectrum channel access on an unlicensed spectrum).

In this way, according to the description in Embodiment 1, the present invention provides a method for determining a symbol set for a sidelink measurement (e.g., a sidelink RSSI) according to information such as a configuration of a starting sidelink symbol of a slot (e.g., the number of starting sidelink symbols), thereby preventing to the greatest extent a situation in which actual sidelink transmission exists in only a portion of multiple symbols measured, and greatly improving the accuracy of the sidelink measurement.

### Embodiment 2

A method performed by a UE according to Embodiment 2 of the present invention will be described below with reference to FIG. 2.

FIG. 2 illustrates a flowchart corresponding to the method performed by a UE according to Embodiment 2 of the present invention.

As illustrated in FIG. 2, in Embodiment 2 of the present invention, the steps performed by the UE include: step S201 and step S203.

Specifically, in step S201, information related to a PSCCH and/or a PSSCH (e.g., denoted as

$${Inf}_{0}^{DA} )$$

is obtained/determined.

$${Inf}_{0}^{DA}$$

may include pre-defined information and/or (pre-)configured information.

$${Inf}_{0}^{DA}$$

may include information received by the UE from another node (e.g., a base station, or another UE).

$${Inf}_{0}^{DA}$$

may include information indicated by (one or more) higher layer entities of the UE.

The PSSCH may be a PSSCH associated with the PSCCH.

The PSSCH may be associated with SCI, wherein the SCI may include sidelink scheduling information.

The SCI may include first-stage SCI and/or second-stage SCI, wherein the first-stage SCI may correspond to SCI format 1-A, or another SCI format; the second-stage SCI may correspond to SCI format 2-A, or SCI format 2-B, or SCI format 2-C, or SCI format 2-D, or another SCI format.

The first-stage SCI may be carried in the PSCCH.

The second-stage SCI may be carried in the PSSCH.

A transmission channel corresponding to the PSSCH may be an SL-SCH (Sidelink Shared Channel).

The PSSCH may carry one TB (e.g., one TB in the SL-SCH).

The PSCCH and/or the PSSCH may be transmitted in a slot (e.g., denoted as

$${t}_{i}^{e , j} )$$

in a resource pool (e.g., denoted as eⱼ). For example, the PSCCH and the PSSCH may be multiplexed in a resource in the slot

$${t}_{i}^{e , j} ,$$

wherein the resource may correspond to one or more subchannels in the slot

$${t}_{i}^{e , j} .$$

The SCI may be used to indicate one or more resources in the resource pool eⱼ, e.g., including resources in which the PSCCH and/or the PSSCH are/is located.

One or more fields in the SCI may be associated with a configuration of the resource pool eⱼ.

PSFCH resource(s) may or may not be configured in the resource pool eⱼ.

If PSFCH resource(s) is not configured in the resource pool eⱼ, it may be considered that HARQ feedback is disabled in the resource pool eⱼ (e.g., HARQ feedback is disabled for all transmissions in the resource pool eⱼ).

A PSFCH period (e.g., denoted as

$${P}_{j}^{F} )$$

in the resource pool eⱼ may be zero slots

$$( i . e . , {P}_{j}^{F} = 0 ) ,$$

one slot

$$( i . e . , {P}_{j}^{F} = 1 ) ,$$

or more than one slot

$$( i . e . , {P}_{j}^{F} > 1 , e . g . , {P}_{j}^{F} = 2 , or {P}_{j}^{F} = 4 ) ,$$

wherein

$${P}_{j}^{F} = 0$$

may correspond to a case where no PSFCH resource is configured.

$${P}_{j}^{F}$$

may correspind to a case where no PSFCH resource is configured.

The SCI (e.g., the first stage SCI) may include a “PSFCH overhead indication” field. A value indicated by the “PSFCH overhead indication” field may be used to determine one or more of the following:
The number of coded modulation symbols generated for the second-stage SCI.
A TBS (transport block size) corresponding to the TB.

Part or all fields of the SCI may be related to predefined or (pre-)configured information. For example, if a type 1 overhead indication condition is met, the size of the “PSFCH overhead indication” field in the first-stage SCI is

$${N}_{1}^{SCI , FO}$$

bits, wherein

$${N}_{1}^{SCI , FO}$$

may be a value of a pre-defined or (pre-)configured parameter

$$( e . g . , {N}_{1}^{SCI , FO} = 1 ; or {N}_{1}^{SCI , FO} = 2 ) ,$$

or may be determined according to a value of one or more pre-defined or (pre-)configured parameters. As another example, if the type 1 overhead indication condition is not met, the size of the “PSFCH overhead indication” field is

$${N}_{2}^{SCI , FO}$$

bits, wherein

$${N}_{2}^{SCI , FO}$$

may be a value of a pre-defined (pre-)configured parameter

$$( e . g . , {N}_{2}^{SCI , FO} = 0 ) ,$$

or may be determined according to a value of one or more pre-defined or (pre-)configured parameters. As another example, if a type 2 overhead indication condition is met, the size of the “PSFCH overhead indication” field is

$${N}_{2}^{SCI , FO}$$

bits. As another example, if the type 2 overhead indication condition is met, the “PSFCH overhead indication” field is a reserved field (e.g., the UE may set the value of the “PSFCH overhead indication” field to any value, such as any value allowed by the “PSFCH overhead indication” field; or, a UE receiving the SCI may ignore the “PSFCH overhead indication” field in the SCI; or, the UE receiving the SCI may assume that the value of the “PSFCH overhead indication” field in the SCI may be any value, such as any value allowed by the “PSFCH overhead indication” field). As another example, if a type 3 overhead indication condition is met, the “PSFCH overhead indication” field is a reserved field. As another example, if the type 2 overhead indication condition is met, the value of the “PSFCH overhead indication” field is set to

$${ν}_{1}^{SCI , FO} ,$$

wherein

$${v}_{1}^{SCI , FO}$$

may be a value of a pre-defined or (pre-)configured parameter

$$( e . g . , {v}_{1}^{SCI , FO} = 0 ; or {v}_{1}^{SCI , FO} = 1 ) ,$$

or may be determined according to a value of one or more pre-defined or (pre-)configured parameters. As another example, if the type 3 overhead indication condition is met, the value of the “PSFCH overhead indication” field is set to

$${v}_{1}^{SCI , FO} .$$

As another example, if the type 2 overhead indication condition is not met, the size of the “PSFCH overhead indication” field is

$${N}_{1}^{SCI , FO}$$

bits.

The type 1 overhead indication condition may include one or more of the following (e.g., any combination in a form of “and” or “or”):
Type 1A overhead determination condition.
Type 1B overhead determination condition.

The type 1A overhead determination condition may include one or more of the following (e.g., any combination in a form of “and” or “or”):

$${P}_{j}^{F} = 2.$$

$${P}_{j}^{F} = 4.$$

$${P}_{j}^{F} \neq 0.$$

$${P}_{j}^{F} > 0.$$

$${P}_{j}^{F} > 1.$$

The type 1B overhead determination condition may include one or more of the following (e.g., any combination in a form of “and” or “or”):
The “two starting sidelink symbols” function is disabled in the resource pool eⱼ (or a corresponding bandwidth part).
The slot

$${t}_{i}^{e , j}$$

is a type I sidelink slot.

The type 1B overhead determination condition may be applicable to (or only applicable to) an operation with shared spectrum channel access (e.g., an operation with shared spectrum channel access on an unlicensed spectrum).

The type 2 overhead indication condition may include one or more of the following (e.g., any combination in a form of “and” or “or”):
Type 2A overhead determination condition.
Type 2B overhead determination condition.

The type 2A overhead determination condition may include one or more of the following (e.g., any combination in a form of “and” or “or”):

$${P}_{j}^{F} = 1.$$

$${P}_{j}^{F} = 0.$$

$${P}_{j}^{F} \leq 1.$$

The type 2B overhead determination condition may include one or more of the following (e.g., any combination in a form of “and” or “or”):
The “two starting sidelink symbols” function is enabled in the resource pool eⱼ (or the corresponding bandwidth part).
The slot

$${t}_{i}^{e , j}$$

is a type 2 sidelink slot.

The type 2B overhead determination condition may be applicable to (or only applicable to) an operation with shared spectrum channel access.

The type 3 overhead indication condition may include one or more of the following (e.g., any combination in a form of “and” or “or”):
Type 1 overhead determination condition.
Type 2B overhead determination condition.

In addition, in step S203, the PSCCH and/or the PSSCH are/is transmitted.

For example, the PSCCH and/or the PSSCH are/is transmitted in the slot

$${t}_{i}^{e , j}$$

in the resource pool eⱼ.

Embodiment 2 of the present invention may be performed by a physical layer entity of the UE.

In Embodiment 2 of the present invention, if the size of a field is 0 bits, it may be said that the field is not present.

In this way, according to the description in Embodiment 2, the present invention provides a method for determining a size, value, and presence of one or more fields in SCI according to information such as a configuration of a starting sidelink symbol of a resource pool (or a slot) (e.g., the number of starting sidelink symbols), thereby effectively preventing unnecessary signaling overheads in a situation in which two starting sidelink symbols are configured, as well as additional processing during transmission and/or reception of the SCI due to unnecessary presence of fields such as “PSFCH overhead indication”.

### Embodiment 3

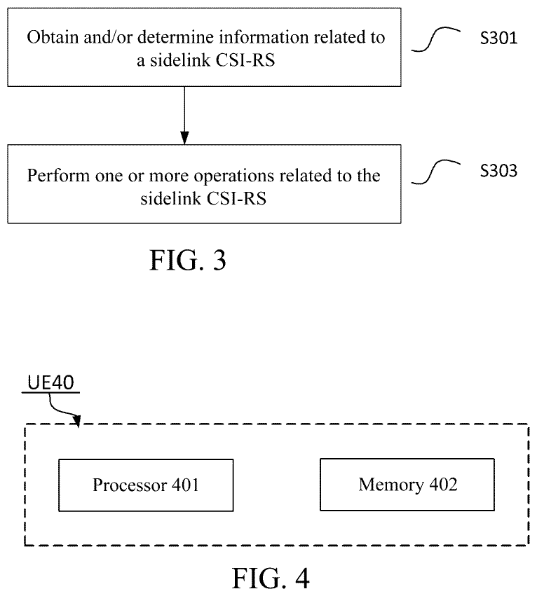

A method performed by a UE according to Embodiment 3 of the present invention will be described below with reference to FIG. 3.

FIG. 3 illustrates a flowchart corresponding to the method performed by the UE according to Embodiment 3 of the present invention.

As illustrated in FIG. 3, in Embodiment 3 of the present invention, the steps performed by the UE include: step S301 and step S303.

Specifically, in step S301, information related to a sidelink CSI-RS (Channel State Information-Reference Signal) (e.g., denoted as

$${Inf}_{0}^{CR} )$$

is obtained/determined.

$${Inf}_{0}^{CR}$$

may include information and/or (pre-)configured information.

$${Inf}_{0}^{CR}$$

may include information received by the UE from another node (e.g., a base station, or another UE).

$${Inf}_{0}^{CR}$$

may include information indicated by (one or more) higher layer entities of the UE.

Part or all of

$${Inf}_{0}^{CR}$$

may be included in a system information block (e.g., NR SIB 12, NR system information block 12).

Part or all of

$${Inf}_{0}^{CR}$$

may be included in one RRC reconfiguration message.

Part or all of

$${Inf}_{0}^{CR}$$

may be included in one sidelink RRC reconfiguration message.

$${Inf}_{0}^{CR}$$

may include a first sidelink SSI-RS configureation and/or a second sidelink CSI-RS configuration, wherein each sidelink CSI-RS configuration may include one or more of the following:
A first CSI-RS symbol.
The number of antenna ports.
A frequency domain allocation (e.g., a frequency domain allocation corresponding to the “number of antenna ports”).

The “first CSI-RS symbol” may be used to indicate the first symbol of the sidelink CSI-RS (or referred to as “the first symbol in a PRB for the sidelink CSI-RS”). The “first CSI-RS symbol” may be represented by a symbol index in a slot. The “first CSI-RS symbol” in the first sidelink CSI-RS configuration may be the same as or different to that in the second sidelink CSI-RS configuration.

One sidelink CSI-RS transmission may correspond to only one symbol in one slot, and accordingly, the “first CSI-RS symbol” is the only symbol in the sidelink CSI-RS transmission.

The “number of antenna ports” may be used to indicate the number of antenna ports for the sidelink CSI-RS. The “numbers of antenna ports” in the first sidelink CSI-RS configuration may be the same as or different to that in the second sidelink CSI-RS configuration.

The “frequency domain allocation” may be used to indicate a subcarrier set allocated in a PRB for the sidelink CSI-RS. For different numbers of antenna ports, the frequency domain allocations may be different. The “frequency domain allocation” in the first sidelink CSI-RS configuration may be the same as or different to that in the second sidelink CSI-RS configuration.

Each item of part or all of the first sidelink CSI-RS configuration may be indicated by means of a corresponding parameter within a parameter sl-CSI-RS-Config (or determined according to the parameter). For example, the “first CSI-RS symbol” in the first sidelink CSI-RS configuration may be indicated by a parameter sl-CSI-RS-FirstSymbol within the parameter sl-CSI-RS-Config.

Each item of part or all of the second sidelink CSI-RS configuration may be indicated by a corresponding parameter within the parameter sl-CSI-RS-Config (or determined according to the parameter). For example, the “first CSI-RS symbol” in the second sidelink CSI-RS configuration may be indicated by means of a parameter sl-CSI-RS-FirstSymbol within the parameter sl-CSI-RS-Config.

Each item of part or all of the second sidelink CSI-RS configuration may be indicated by a corresponding parameter within a parameter sl-2nd-CSI-RS-Config (or determined according to the parameter). For example, the “first CSI-RS symbol” in the second sidelink CSI-RS configuration may be indicated by means of a parameter sl-CSI-RS-FirstSymbol within the parameter sl-2nd-CSI-RS-Config.

Optionally, if the parameter sl-CSI-RS-Config is not present, then neither the first sidelink CSI-RS configuration nor the second sidelink CSI-RS configuration is present.

Optionally, if the parameter sl-2nd-CSI-RS-Config is not present, then the second sidelink CSI-RS configuration is not present.

Optionally, if the parameter sl-2nd-CSI-RS-Config is not present, an item in the second sidelink CSI-RS configuration may be indicated by a corresponding parameter within the parameter sl-CSI-RS-Config (or determined according to the parameter), for example, the “first CSI-RS symbol” in the second sidelink CSI-RS configuration may be indicated by a parameter sl-CSI-RS-FirstSymbol within the parameter sl-CSI-RS-Config.

Furthermore, in step S303, one or more operations related to the sidelink CSI-RS are performed.

For example, if a sidelink transmission (e.g., denoted as

$${Tr}_{i}^{e , j} )$$

in a slot (e.g., denoted as

$${t}_{i}^{e , j} )$$

in a resource poor (e.g., eⱼ) meets a type 1 sidelink CSI condition, then a sidelink CSI-RS is included in the sidelink transmission

$${Tr}_{i}^{e , j}$$

(or referred to as “a CSI-RS is transmitted in the sidelink transmission

$${Tr}_{i}^{e , j} ” )$$

As another example, configuration information corresponding to the sidelink CSI-RS (e.g., the sidelink CSI-RS included in the sidelink transmission

$${Tr}_{i}^{e , j}$$

in the slot

$${t}_{i}^{e , j}$$

in the resource pool eⱼ) is determined. Specifically, for example, if a type 2 sidelink CSI condition is met, part or all of the first sidelink CSI-RS configuration (e.g., the “first CSI-RS symbol”, and/or the “number of antenna ports”, and/or the “frequency domain allocation”) is applied. As another example, if a type 3 sidelink CSI condition is met, part or all of the second sidelink CSI-RS configuration (e.g., the “first CSI-RS symbol”, and/or the “number of antenna ports”, and/or the “frequency domain allocation”) is applied.

The type 1 sidelink information condition may include one or more of the following (e.g., any combination in a form of “and” or “or”):
Type 1A sidelink CSI condition.
Type 1B sidelink CSI condition.

The type 1A sidelink CSI condition may include one or more of the following (e.g., any combination in a form of “and” or “or”):
CSI reporting is enabled. For example, the CSI reporting has been enabled via a parameter sl-CSI-Acquisition.
A “CSI request” field in second-stage SCI corresponding to the sidelink transmission

$${Tr}_{i}^{e , j}$$

is set to a pre-uenneu or (pre-)configured value (e.g., 1; or, 0).

The type 1B sidelink CSI condition may include one or more of the following (e.g., any combination in a form of “and” or “or”):
Type 1B-1 sidelink CSI condition.
Type 1B-2 sidelink CSI condition.
Type 1B-3 sidelink CSI condition.
Type 1B-4 sidelink CSI condition.

The type 1B sidelink CSI condition may be applicable to (or only applicable to) an operation with shared spectrum channel access.

The type 1B-1 sidelink CSI condition may include one or more of the following (e.g., any combination in a form of “and” or “or”):
The slot

$${t}_{i}^{e , j}$$

is a type 1 Sidelink slot.
The sidelink transmission

$${Tr}_{i}^{e , j}$$

corresponds to a first starting sidelink symbol in the slot

$${t}_{i}^{e , j} .$$

The type 1B-2 sidelink CSI condition may include one or more of the following (e.g., any combination in a form of “and” or “or”):
The slot

$${t}_{i}^{e , j}$$

is a type 2 sidelink slot.
The sidelink transmission

$${Tr}_{i}^{e , j}$$

corresponds to a first starting sidelink symbol in the slot

$${t}_{i}^{e , j} .$$

The type 1B-3 sidelink CSI condition may include one or more of the following (e.g., any combination in a form of “and” or “or”):
The slot

$${t}_{i}^{e , j}$$

is a type 2 sidelink slot.
The sidelink transmission

$$T {r}_{i}^{e , j}$$

corresponds to a second starting sidelink symbol in the slot

$${t}_{i}^{e , j} .$$

The type 2 sidelink CSI condition may include one or more of the following (e.g., any combination in a form of “and” or “or”):
Type 2A sidelink CSI condition.
Type 2B sidelink CSI condition.

The type 2A sidelink CSI condition may be that the slot

$${t}_{i}^{e , j}$$

is a type 1 sidelink slot.

The type 2B sidelink CSI condition may include one or more of the following (e.g., any combination in a form of “and” or “or”):
The slot

$${t}_{i}^{e , j}$$

is a type 1 sidelink slot.
The slot

$${t}_{i}^{e , j}$$

is a type 2 sidelink slot.
The sidelink transmission

$$T {r}_{i}^{e , j}$$

is a sidelink transmission corresponding to a first starting sidelink symbol in the slot

$${t}_{i}^{e , j} .$$

The type 3 sidelink CSI condition may include one or more of the following (e.g., any combination in a form of “and” or “or”):
The slot

$${t}_{i}^{e , j}$$

is a type 2 sidelink slot.
The sidelink transmission

$$T {r}_{i}^{e , j}$$

is a sidelink transmission corresponding to a second starting sidelink symbol in the slot

$${t}_{i}^{e , j} .$$

Embodiment 3 of the present invention may be performed by a physical layer entity of the UE.

In Embodiment 3 of the present invention, “indication” may be replaced by “(pre-)configuration”.

In Embodiment 3 of the present invention, the sidelink transmission

$$T {r}_{i}^{e , j}$$

may be a PSCCH/PSSCH transmission.

In Embodiment 3 of the present invention, the sidelink transmission

$$T {r}_{i}^{e , j}$$

may be a PSSCH transmission.

In Embodiment 3 of the present invention, the sidelink transmission

$$T {r}_{i}^{e , j}$$

may be a transmission that has been scheduled but not yet performed.

In Embodiment 3 of the present invention, the sidelink transmission

$$T {r}_{i}^{e , j}$$

may be a unicast transmission.

In this way, according to the description in Embodiment 3, the present invention provides a method for determining one or more pieces of configuration information of a sidelink CSI-RS according to information such as a configuration of a starting sidelink symbol of a resource pool (or a slot) (e.g., the number of starting sidelink symbols), so that the configuration information (e.g., a first CSI-RS symbol) may correctly match a starting sidelink symbol corresponding to the sidelink transmission (e.g., PSSCH transmission) in which the sidelink CSI-RS is located.

### Variant Embodiment

Hereinafter, FIG. 4 is used to illustrate a user equipment, as a variant embodiment, that can perform the method performed by a user equipment described in detail above in the present invention.

FIG. 4 is a block diagram showing the user equipment according to the present invention.

As illustrated in FIG. 4, the user equipment (UE) 40 includes a processor 401 and a memory 402. The processor 401 may include, e.g., a microprocessor, a microcontroller, an embedded processor, etc. The memory 402 may, for example, include a volatile memory (e.g., a random access memory (RAM)), a hard disk drive (HDD), a non-volatile memory (e.g., a flash memory), or other memories. The memory 402 has program instructions stored thereon. The instructions, when run by the processor 401, can perform the method performed by user equipment described in detail in the present invention.

The method and related user equipment according to the present invention have been described above in combination with preferred embodiments. It should be understood by those skilled in the art that the method shown above is only exemplary, and the above-described embodiments can be combined with one another as long as no contradiction arises. The method of the present invention is not limited to the steps or sequences illustrated above. The user equipment illustrated above may include more modules. Various identifiers illustrated above are only exemplary, and are not meant to be limiting. The present invention is not limited to specific information elements serving as examples of these identifiers. Those skilled in the art could make various alterations and modifications according to the teachings of the illustrated embodiments.

It should be understood by those skilled in the art that any set is its own subset. An empty set is a subset of any set. Part or all of the mathematical expressions, mathematical equations, or mathematical inequalities may be simplified or transformed or rewritten to some extent (e.g., merging constant terms, or interchanging two addition terms, or interchanging two multiplication terms, or moving a term from the left side of an equation or inequality to the right side after changing the plus or minus sign thereof, or moving a term from the right side of an equation or inequality to the left side after changing the plus or minus sign thereof, or the like). Mathematical expressions, mathematical equations, or mathematical inequalities before and after the simplification or transformation or rewriting may be considered to be equivalent to each other.

It should be understood that the above-described embodiments of the present invention may be implemented by means of software, hardware, or a combination of software and hardware. For example, various components in the user equipment in the above embodiments may be implemented by means of multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

In the present invention, the term “base station” may refer to mobile communication data and/or a control switching center having a certain transmission power and a certain coverage area, and, for example, having functions such as resource allocation and scheduling, and data reception and transmission. The term “user equipment” may refer to user mobile terminals, such as terminal devices that can wirelessly communicate with a base station or a micro base station, including a mobile phone, a laptop computer, and the like.

In addition, the embodiments of the present invention disclosed herein may be implemented on a computer program product. More specifically, the computer program product is a product provided with a computer-readable medium having computer program logic encoded thereon. When performed on a computing device, the computer program logic provides related operations to implement the above technical solutions of the present invention. When performed on at least one processor of a computing system, the computer program logic enables the processor to perform the operations (methods) described in the embodiments of the present invention. Such an arrangement of the present invention is typically provided as software, code, and/or other data structures that are configured or encoded on a computer-readable medium, such as an optical medium (e.g., a CD-ROM), a floppy disk or a hard disk, or, for example, firmware or other media of microcodes on one or more ROM or RAM or PROM chips, or downloadable software images, shared database and so on in one or more modules. Software or firmware or such configuration may be installed on a computing device such that one or more processors in the computing device performs the technical solutions described in the embodiments of the present invention.

In addition, each functional module or each feature of the user equipment used in each of the above embodiments may be implemented or performed by a circuit, and the circuit is usually one or more integrated circuits. Circuits designed to perform various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general-purpose processor may be a microprocessor, or the processor may be an existing processor, a controller, a microcontroller, or a state machine. The aforementioned general-purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-2. (canceled)

3. A user equipment, comprising:
a processor; and
a memory storing instructions, wherein the instructions, when run by the processor, perform:
determining a sidelink received signal strength indicator (SL RSSI) as the linear average of the total received power in watts in a sub-channel in a set of OFDM symbols in a slot, wherein:
the set of OFDM symbols are OFDM symbols configured for PSCCH and PSSCH;
the set of OFDM symbols starts from the next symbol of a first candidate starting sidelink symbol configured by a first parameter for a sidelink bandwidth part (SL BWP) in a case that the slot is configured with PSFCH;
the set of OFDM symbols starts from the next symbol of a second candidate starting sidelink symbol configured by a second parameter for the SL BWP in a case that the slot is configured without PSFCH; and
the second candidate starting sidelink symbol is later than the first candidate starting sidelink symbol.

4. The user equipment according to claim 3, wherein:
a total number of candidate starting sidelink symbols in the slot is 1 in a case that the slot is configured with PSFCH; and
the total number of candidate starting sidelink symbols in the slot is 2 in a case that the slot is configured without PSFCH.

5. A method performed by a user equipment, the method comprising:
determining a sidelink received signal strength indicator (SL RSSI) as the linear average of the total received power in watts in a sub-channel in a set of OFDM symbols in a slot, wherein:
the set of OFDM symbols are OFDM symbols configured for PSCCH and PSSCH;
the set of OFDM symbols starts from the next symbol of a first candidate starting sidelink symbol configured by a first parameter for a sidelink bandwidth part (SL BWP) in a case that the slot is configured with PSFCH;
the set of OFDM symbols starts from the next symbol of a second candidate starting sidelink symbol configured by a second parameter for the SL BWP in a case that the slot is configured without PSFCH; and
the second candidate starting sidelink symbol is later than the first candidate starting sidelink symbol.
